(19) United States
(12) Patent Application Publication
(10) Pub. No.: US 2022/0271520 A1
(43) Pub. Date: Aug. 25, 2022

(54) CABLE FEEDTHROUGH FOR A CONTROL CABINET

(71) Applicant: KUKA Deutschland GmbH, Augsburg (DE)

(72) Inventors: Dietmar Steidl, Augsburg (DE); Alexander Rottmair, Wertingen (DE)

(21) Appl. No.: 17/623,647

(22) PCT Filed: Jun. 23, 2020
(86) PCT No.: PCT/EP2020/067436

§ 371 Date: Dec. 29, 2021

(30) Foreign Application Priority Data
Jul. 9, 2019 (DE) 20 2019 002 833.1

(51) Int. Cl. H02G 3/08; H02G 3/14; H02G 15/013

(52) U.S. Cl. CPC H02G 3/083; H02G 3/14; H02G 15/013

(57) ABSTRACT

A cable feedthrough for a control cabinet having a casing that can be closed with a casing cover. The cable feedthrough includes a frame which is open on one side and can be fastened detachably to and flush with an end face of the casing. At least one removable feed element for feeding through a cable is situated in the frame.

### CROSS-REFERENCE TO RELATED APPLICATIONS

This application is a national phase application under 35 U.S.C. § 371 of International Patent Application No. PCT/EP2020/067436, filed Jun. 23, 2020 (pending), which claims the benefit of priority to German Patent Application No. DE 20 2019 002 833.1, filed Jul. 9, 2019, the disclosures of which are incorporated by reference herein in their entirety.

### TECHNICAL FIELD

The invention relates to a cable feedthrough for a control cabinet, and to a control cabinet.

### BACKGROUND

In an industrial environment, higher degrees of protection are usually required for equipment, e.g. control cabinets, due to the surroundings. In order to get cables from the unprotected outside region into the clean interior of the control cabinet, plugs (if plug-in capability is required outside) or cable feedthroughs in the appropriate protection class are usually used.

Cables having plugs that are protected against dust and splash water from all directions, for example, have the main disadvantage of significantly higher costs than cable feedthroughs having inexpensive internal plug connections of a lower protection class. However, such cable feedthroughs often entail much more effort when replacing cables than a plug connection on the outside of the control cabinet.

Multiple cable feedthroughs are known from the prior art. However, most cable feedthrough systems require tools (e.g. screwdrivers) to remove/add or replace a cable, which makes conversion time-consuming. Even with the tool-free solutions, the entire installation frame together with all the cables must be removed, dismantled and then completely reassembled. All of the cables must then be threaded through the cabinet cutout. Plugs larger than the cabinet cutout cannot be used.

However, toolless systems work equivalently. This is—especially when only replacing a single cable—not particularly quick and practical.

### SUMMARY

It is therefore an object of the invention to provide a cable feedthrough for a control cabinet that is constructed in a simple manner and allows a cable to be changed or replaced quickly and without tools. This object is achieved by a device and by a control cabinet as described herein.

The present invention relates to a cable feedthrough for a control cabinet having a casing that can be closed with a casing cover, wherein the cable feedthrough comprises a frame that is open on one side and can be fastened detachably to and flush with an end face of the casing, wherein at least one removable feed element for feeding through a cable is situated in the frame.

Due to the at least one removable feed element for feeding the cable through, the change or replacement of a cable that is to be routed into the interior of a control cabinet can be done without tools because only the feed element and the cable have to be removed from the frame of the cable feedthrough, which is open on one side. The frame of the cable feedthrough, which is detachably fastened to the casing, remains flush with the end face of the casing.

The feed element can preferably have an opening on one side for feeding the cable through. The cable can be inserted or pressed into the feed element through the slot from the side. There is no need to thread the cable through the casing, which may be provided with a plug, because the cable can be pressed into the feed element, regardless of the size of the plug.

For this purpose, the feed element can preferably be made of a polymer or an elastomer, e.g. a thermoplastic elastomer or rubber. Such a design prevents dust, splash water or other contamination from penetrating into the casing via the feed element because the feed element surrounds the cable in a dust-tight or fluid-tight manner and in particular makes mechanical contact with or clamps the cable jacket.

In an advantageous embodiment, the frame of the cable feedthrough can have a plurality of feed elements in different sizes for receiving cables having different diameters. Due to the different design of the feed elements, cables of different diameters are also enclosed in a fluid-tight manner and fed safely.

In a further aspect of the invention, a control cabinet having a cable feedthrough according to the invention is provided, wherein the casing cover of the casing of the control cabinet has a circumferential sealing element that, when the casing is closed, rests against the end face and locks the frame and the at least one feed element in place and seals them in a fluid-tight manner.

The circumferential sealing lip seals the feed elements and the frame against dust, water or other contamination that can get into the casing and also securely holds or locks them in position. Individual feed elements can therefore not slip out of the frame.

In an advantageous embodiment, the casing cover is detachably situated on the casing by means of hinges. As a result of the detachable attachment, the casing cover can be temporarily removed when changing or replacing the cables or when assembling the frame if the opening angle of the casing cover is not sufficient when the casing cover is attached to the casing.

In a further advantageous embodiment, the casing of the control cabinet has a recess in which the frame of the cable feedthrough can be fastened and wherein the frame covers the recess in some regions.

Due to the recess and the frame adapted thereto, the cable feedthrough can be inserted flush with the end face of the casing such that the sealing lip of the casing cover can also rest flush.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a cable feedthrough for a control cabinet;

FIG. 2 shows a control cabinet having a cable feedthrough with the casing cover open;

FIG. 3 shows a control cabinet having a cable feedthrough having a closed cable feedthrough;

### DETAILED DESCRIPTION

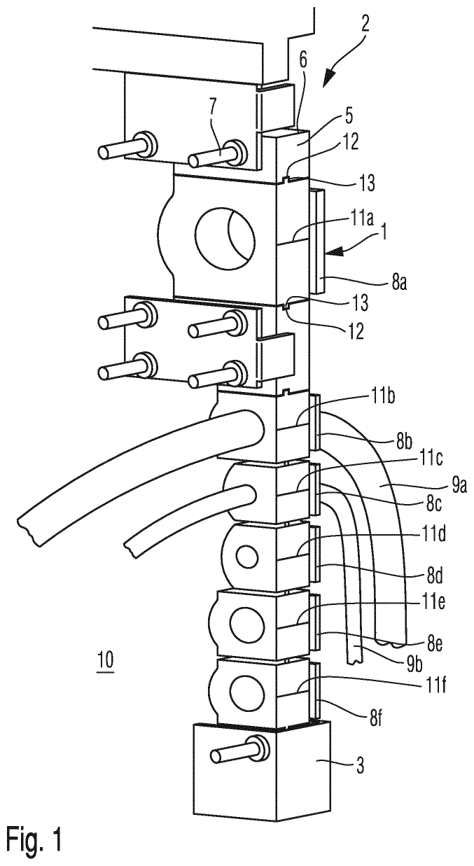

FIG. 1 is a perspective view of the cable feedthrough 1 for a control cabinet 2 having a casing 3. The control cabinet 2 can be closed with a casing cover 4 (not shown here). The cable feedthrough 1 comprises a frame 5 that is open on one side and is formed from a plastic. It would also be conceivable to use other materials, for example metal. The frame 5 is fastened detachably to and flush with an end face 6 of the casing 2. In the embodiment shown, the fastening takes place via a screw connection 7. It should be understood that further fastening means, for example gluing or a press fit, can also be used.

Furthermore, the cable feedthrough 1 has feed elements 8a-8f that are detachably situated in the frame 5. The feed elements 8a-8f serve to feed a cable 9a, 9b through into an interior 10 of the casing 2.

In order to feed the cables 9a, 9b into the interior 10, an opening 11a-11f in the form of a slot is provided on one side of the feed elements 8a-8f. The cable 9a, 9b is pressed into the feed element 8a-8f through said opening 11a-11f. Likewise, the cable 9a, 9b can be removed or pushed out of the feed element 8a-8f from said opening 11a-11f. Replacing or changing or inserting the cables 9a, 9b for the first time does not require any tools because the cables 9a, 9b can only be pressed in by hand.

Because the feed elements 8a-8f consist of a polymer or an elastomer such as rubber, the feed elements 8a-8f are deformable to a certain extent. That is to say, after the cable 9a, 9b has been pressed in, the feed elements 8a-8f rest in a fluid-tight manner around the cable 9a, 9b and thus protect against the ingress of dust, splash water or other contamination of the interior 10 of the casing 2.

If not all of the feed elements 8a-8f are required to feed a cable 9a, 9b through, the feed elements 8a-8f that are not required can also be made of solid material so that the control cabinet 2 is still protected from the ingress of dust, spray water or other contamination.

For the detachable arrangement of the feed elements 8a-8f in the frame 5, the frame 5 has grooves 12 in which webs 13 formed on the feed elements 8a-8f engage or are guided. For the sake of clarity, this is only shown on one feed element.

The feed elements 8a-8f are designed in different sizes, such that the cable 9a, 9b can be fed through in different diameters while still providing a fluid-tight seal.

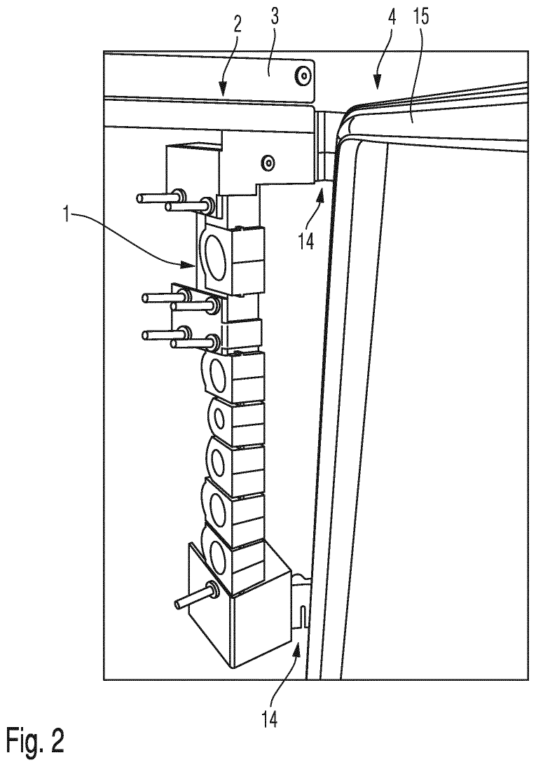

FIG. 2 shows a control cabinet 2 having a cable feedthrough 1 detachably attached to the casing 3 without a cable 9a, 9b passed through, wherein the casing cover 4 is situated on the casing 3 by means of hinges 14, such that the casing cover 4 can close the casing 2. Furthermore, a circumferential sealing lip 15, which is also made of a polymer or elastomer, for example rubber, is situated on the casing cover 4.

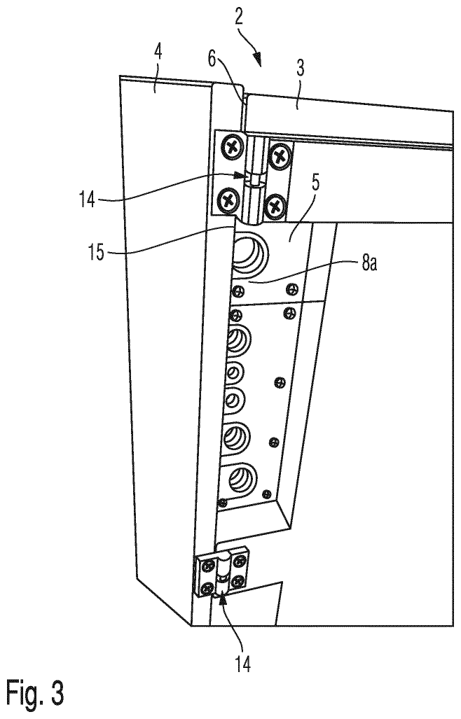

In FIG. 3, the casing 3 of the control cabinet 2, which is closed by the casing cover 4, is shown, wherein the casing cover 4 is situated on the hinges 14. When the casing cover 4 is closed, the sealing lip 15 rests against the end face 6 of the casing 3 and thus also against the frame 5 and the feed elements 8a-8f. For the sake of clarity, only one feed element 8a is designated.

The feed elements 8a-8f and the frame 5 are locked in place by the contact of the sealing lip 15 and, moreover, also sealed in a fluid-tight manner. In other words, the penetration of dust, spray water or other contamination into the casing 2 is prevented.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### REFERENCE SIGNS

1 cable feedthrough
2 control cabinet
3 casing
4 casing cover
5 frame
6 end face
7 screw connection
8a-8f feed element
9a-b cable
10 interior
11a-f opening
12 groove
13 web
14 hinge
15 sealing lip

What is claimed is:

1-8. (canceled)

9. A cable feedthrough for a control cabinet having a casing that can be closed with a casing cover, the cable feedthrough comprising:
a frame that is open on one side;
the frame designed for detachable fastening to and flush with an end face of the casing; and
at least one feed element designed for feeding a cable therethrough and removably arranged in the frame.

10. The cable feedthrough of claim 9, wherein the feed element has an opening on one side designed for feeding the cable therethrough.

11. The cable feedthrough of claim 9, wherein the at least one feed element comprises a plurality of feed elements situated in the frame, the plurality of feed elements having different sizes designed for receiving cables of different diameters therethrough.

12. The cable feedthrough of claim 9, wherein the at least one feed element is formed from a polymer or an elastomer.

13. The cable feedthrough of claim 9, wherein:
the frame further comprises at least one groove; and
the at least one feed element comprises a web having a shape complementary to the at least one groove, whereby the web is received within the groove to facilitate the removable arrangement of the feed element in the frame.

14. A control cabinet, comprising:
a casing that can be closed with a casing cover;
a cable feedthrough according to claim 9;
a circumferential sealing element on the casing cover and designed such that, in a closed condition of the casing cover, the sealing element rests against the end face and locks the frame and the at least one feed element in place.

15. The control cabinet of claim 14, wherein the sealing element seals the frame and at least one feed element in at least one of a dust-tight or fluid-tight manner in the closed condition of the casing cover.

16. The control cabinet of claim 14, wherein the casing cover is detachably arranged on the casing by hinges.

17. The control cabinet of claim 14, further comprising:
a recess in the casing;
the frame being fastenably coupled with the casing at the recess and covering the recess in at least some regions.
